(19) United States
(12) Patent Application Publication
(10) Pub. No.: US 2024/0343630 A1
(43) Pub. Date: Oct. 17, 2024

(54) METHOD FOR MOULDING A GLASS ITEM, IN PARTICULAR A THREE-DIMENSIONALLY MOULDED PLANAR GLASS ITEM, AND DEVICE FOR CARRYING OUT THE METHOD, AND USE OF A METAL MELT FOR CARRYING OUT THE METHOD

(71) Applicant: FÜLLER GLASTECHNOLOGIE VERTRIEBS-GmbH, Spiegelau (DE)

(72) Inventors: Alexandra FÜLLER, Neuburg am Inn (DE); Bernhard ALTENDORFER, Waldkirchen (DE)

(21) Appl. No.: 18/291,986

(22) PCT Filed: Jun. 15, 2022
(86) PCT No.: PCT/EP2022/066385

§ 371 Date: Jan. 25, 2024

(30) Foreign Application Priority Data
Jul. 26, 2021 (DE) 10 2021 119 253.6

(51) Int. Cl. C03B 18/18; C03B 11/00; C03B 11/07; C03B 11/12; C03B 11/16

(52) U.S. Cl. CPC C03B 18/18; C03B 11/005; C03B 11/07; C03B 11/122; C03B 11/16; C03B 2215/06; C03B 2215/07; C03B 2215/11; C03B 2215/12; C03B 2215/50

(57) ABSTRACT

The invention relates to a method for forming a glass item, in particular a three-dimensionally formed flat glass item, wherein the following steps are carried out: arranging a flat formation of glass, for example a flat glass pane of homogeneous thickness or a flat glass pane of inhomogeneous thickness or a preformed flat glass pane blank or liquid two-dimensionally spread glass, between a mould plunger and a melt of liquid metal, in particular tin; tempering of at least one part to be formed of the flat formation of glass to a forming temperature of the glass at which the glass has a viscosity in the range from 10 Pas to 106.5 Pas, preferably in the range from 10 Pas to 104 Pas and particularly preferably in the range from 10 Pas to 103 Pas; forming the flat formation of glass by moving the mould plunger and a surface of the molten metal towards each other, preferably by means of at least one linear movement, for example by means of a linear motor or servomotor, so that the flat formation of glass is pressurised either by the mould plunger on the one hand and by the molten metal on the other hand and is formed by the pressurisation on both sides and/or by suctioning and conforming the flat formation of glass onto the mould plunger; cooling the formed flat formation of glass to a handling temperature below the forming temperature at which the glass has a viscosity of ≥107 Pas; and demoulding the cooled flat formation; as well as a device for carrying out the method and a use of a molten metal for carrying out the method.

The invention relates to a method for forming a glass item, in particular a three-dimensionally formed flat glass item, according to the preamble of patent claim 1, a device for producing such a glass item according to the preamble of patent claim 8, as well as a use of a molten metal for producing such a glass item according to the preamble of patent claim 15.

Methods for forming glass items, namely in particular three-dimensionally formed flat glass items, such as, for example, mobile phone or tablet covers or motor vehicle windows, have been known for some time and are based in most cases on the fact that a flat glass blank is either pressed into the desired form and/or ground into the desired form. In the pressing process, a plunger tool with a plunge and counter-plunger is used, whereby the plunger and the counter-plunger are each formed in a complementary manner, i.e. for example concave and convex, in the form of the three-dimensionally formed flat glass item to be produced.

One problem with this manufacturing process is that both the plunger and the counter-plunger inevitably come into contact with the glass item to be pressed during the pressing process, but this is disadvantageous with regard to the quality of the pressed glass surface. An optimisation of the quality of the glass surface can indeed be improved by the use of certain suitable glass contact materials on the contact surfaces of the pressing tools; however, a post-processing of the respective glass surface is usually still necessary, especially if a high quality of the respective pressed surface is required.

In the moulding and forming of glass, mainly cast and steel alloys are used, or chrome coatings of steel alloys, which, however, result in adhesion of glass in the form of sticking when a limit temperature is exceeded. The moulds are therefore designed in such a way that their temperatures are kept within a temperature range of below 500° C., while the forming of glasses takes place at viscosities of 10 Pas to 10⁶ Pas and thus in temperature ranges of 800° C. to 1500° C.

The resulting temperature gradient of glass and glass contact material also results in a temperature gradient within the respective moulded glass component. The forming process is therefore limited in time by the different thermal expansion of glass and glass contact material in different temperature ranges. This time limitation in the moulding process according to the state of the art shall, among other things,
avoid an overheating of the mould, which cannot dissipate the heat introduced by the glass quickly enough and heats up above the critical bonding temperature;
avoid that the glass can no longer be separated from the mould, because a faster shrinkage of the glass at high temperatures causes the glass to shrink onto the mould component which responsible for the inner contour of the workpiece, i.e. onto convex sections of the plunger;
avoid that the glass cannot achieve sufficient homogenisation of the temperature gradients within the component in the moulding process and that surface cracks, deformations occur due to distortions, because no re-heating of the surface can take place due to the infrared radiation stored inside the glass.

In the state of the art, this leads to an extremely complex and difficult process control, which nevertheless has disadvantages in terms of the glass quality obtained.

As mentioned above, a further possibility for the production of three-dimensionally formed flat glass items consists in grinding a glass blank by ablation until this blank has assumed the desired three-dimensional form; however, this process is also disadvantageous and, in particular, also time-consuming and, moreover, if a high quality of the respective glass surface is required, it is tedious and difficult to carry out.

The invention is based on the object of providing an alternative method for forming, i.e. producing, three-dimensionally formed flat glass items, which enables high-precision production of flat glass items with simultaneous high quality of the glass surface and reduces a possible need for post-processing to a minimum, as well as also to provide a device for carrying out such a method.

This object is solved by a method according to patent claim 1, a device according to patent claim 8 as well as a use according to patent claim 15.

In particular, this object is solved by a method for forming a glass article, in particular a three-dimensionally formed flat glass item, wherein the following steps are carried out.
a) Placing a flat formation of glass, for example a flat glass pane of homogeneous thickness or a flat glass pane of inhomogeneous thickness or a preformed flat glass pane blank or liquid two-dimensionally spread glass, between a mould plunger and a molten metal, i.e. a melt of liquid metal, in particular a molten tin;
b) tempering the flat formation of glass to a forming temperature of the glass at which the glass has a viscosity in the range from 10 Pas to 10^{6.5} Pas, preferably in the range from 10 Pas to 10⁴ Pas and particularly preferably in the range from 10 Pas to 10³ Pas; c) forming the flat formation of glass by moving the mould plunger and a surface of the molten metal towards each other so that the flat formation of glass is pressurised on the one hand by the mould plunger and on the other hand by the molten metal and is formed by the pressurisation on both sides and/or by suctioning and conforming the flat formation of glass onto the mould plunger;
d) cooling the formed flat formation of glass to a handling temperature below the forming temperature at which the glass has a viscosity of ≥10⁷ Pas; and
e) demoulding the cooled flat formation.

An essential point of the invention lies in the fact that the method according to the invention is carried out as a pressing process, although only a mould plunger in the form of a solid, hard mould plunger is used, while a molten metal of liquid metal is used as a counter plunger. According to the invention, liquid tin is preferably used as the liquid metal, since tin is extremely inert to glass and enables a production of glass surfaces with a very high surface quality. Furthermore, a tin bath with liquid tin can be heated to high temperatures which enable a moulding of glass.

In the process according to the invention, a flat formation of glass is introduced into a moulding space which is arranged between a volume or container for receiving a molten metal, such as a metal bath, and a mould plunger. Subsequently, the flat formation of glass, i.e. the glass blank, is then tempered to a forming temperature.

In this context, it should be noted that the volume or the container for receiving the molten metal may already be filled with the molten metal during the introduction of the flat formation of glass into the moulding space.

However, according to an alternative embodiment of the invention, it is also possible that the molten metal is introduced into the volume provided for the molten metal, or the container provided for the molten metal, only after the flat formation of glass has been introduced into the moulding space.

According to a further embodiment, it is further possible that during the introduction of the flat formation of glass, there is already molten metal in the volume or container for the molten glass, but that subsequently a levelling of the surface of the molten metal is carried out. In this case, it is possible to increase the level of the molten metal, for example by raising the metal bath and/or by a further addition of molten metal, or, as required, to lower it, for example by a withdrawal of molten metal from the volume or container.

In the context of the invention, the forming temperature of the glass is understood to be a temperature at which the respective glass to be moulded has a viscosity in the range from 10 Pas to 10^{6.5} Pas, preferably in the range from 10 Pas to 10⁴ Pas and particularly preferably in the range from 10 Pas to 10³ Pas. In an advantageous manner, a glass blank of flat glass having such a viscosity which is in the range indicated can be formed into a desired three-dimensional form to produce a three-dimensionally formed flat glass item in a manner accordance to the invention.

After the glass blank, i.e. the flat formation of glass, has been brought to the forming temperature of the glass, the mould plunger and the molten metal are moved towards each other so that by the pressurisation of the glass blank a three-dimensional forming of the flat formation of glass into the desired three-dimensionally formed glass item results.

According to the invention, a prefabricated glass blank can be used as the starting glass body or as the starting flat formation, which is formed as a flat glass pane of homogeneous thickness or, depending on the desired three-dimensional glass item to be formed, also of inhomogeneous thickness or already preformed flat glass pane blank.

Furthermore, according to the invention, it is also possible to use liquid glass as the starting glass, which is introduced between the mould plunger and the molten metal and is then formed when the mould plunger and molten metal move towards each other.

According to one embodiment of the invention, the actual forming of the glass blank into the desired three-dimensionally formed flat glass item is effected in that a three-dimensional mould contour of the mould plunger presses into the softened flat glass blank in the course of a movement of the mould plunger and the molten metal towards each other, as a result of which the side of the flat glass blank facing away from the mould plunger is in turn pressed into the molten metal serving as a counter-plunger.

In this, according to the invention, the molten metal serves as a counter-plunger to the mould plunger, whereby the molten metal conforms to the softened flat glass blank and in turn presses the softened flat glass blank homogeneously and uniformly against the three-dimensional mould contour of the mould plunger in an interaction of its surface tension and its hydraulic pressure.

The movement of the mould plunger and the molten metal towards each other can be effected in different ways.

According to one embodiment of the invention, the molten metal is preferably below the mould plunger, whereby when the molten metal and the mould plunger are moved towards each other, both the level of the molten metal can be raised and, optionally simultaneously, the mould plunger can be lowered.

In order to prevent the mould plunger, or the softened flat glass item guided by the mould plunger, from being driven or pressed too far into the molten metal when the molten metal and the mould plunger move together or upon moulding the desired three-dimensionally formed flat glass item, both the pressure building up during the moulding process is precisely monitored on the one hand and on the other hand the movement of the molten metal bath and the mould plunger towards each other is precisely controlled. In addition, the mould plunger is moved as desired within a guide that precisely surrounds the mould plunger and guides the mould plunger, whereby the guide closes off a volume located to the side of the mould plunger, in particular in a sealing manner, so that the level of the molten metal can rise at most up to a lower surface of the guide during an immersion of the flat glass item and mould plunger in the molten metal. A further immersion of the mould plunger, respectively of the softened flat glass item guided by the mould plunger, into the molten metal would lead to an immediate, well measurable pressure increase at the mould plunger and the guide on the one hand and the metal bath on the other hand.

In the same way, a pressure increase also occurs when the softened flat glass item is pressed homogeneously over its entire surface against the mould contour of the mould plunger and fits against it. Since no further deformation of the flat glass item can take place in this state, any further movement of the molten metal and the mould plunger towards each other results in a clearly measurable increase in pressure, which signals the end of the forming process.

Since the pressure building up in the molten metal during the pressing process is homogeneous in the entire molten metal, the process according to the invention results in a homogeneous pressing of the soft flat glass blank against the three-dimensional mould contour of the mould plunger over the entire surface of the flat glass blank, so that any stresses in the finished formed flat glass item, as occur in conventional glass presses, can be avoided in the process according to the invention.

According to an alternative embodiment of the invention, the mould plunger may have openings by means of which either an overpressure or an underpressure may be applied to the flat body of glass being adjacent to the mould plunger during a forming operation, as desired and depending on operating condition.

By means of such a mould plunger, which has openings for applying an underpressure to the flat glass body, a forming of the flat glass body can also take place according to the invention also in that the metal bath on the one hand and the mould plunger on the other hand approach one another, wherein an underpressure applied via the mould plunger sucks the flat body of glass as soon as a distance between the flat body of glass and the mould plunger falls below a distance defined in dependence of the underpressure applied.

As soon as the flat body of glass and the mould plunger have thus come sufficiently close to each other, according to the invention, a forming of the flat body of glass, which has been tempered to the forming temperature, can occur in that the mould plunger sucks the tempered flat body of glass, whereby the tempered flat body of glass conforms exactly to the contour of the mould plunger predetermined by the mould plunger.

In such a forming process according to the invention, it is possible that the tempered flat body of glass is lifted off the surface of the metal bath by the suction exerted by the mould plunger. According to the invention, a related advantage is that the flat formation of glass initially resting on the liquid metal surface is removed from the hot liquid metal surface, which is substantially at forming temperature, by such lifting and, by the contact with the cooler mould plunger, cools immediately or at least very quickly after the glass has conformed onto it due to the underpressure exerted by the mould plunger, and solidifies in the desired form predetermined by the mould plunger. The cooling of the glass to a viscosity at which the flat body of glass is sufficiently dimensionally stable so that it can be handled for further treatment takes place due to a contact between the flat body of glass, which is initially at the forming temperature, and the cooler mould plunger, which dissipates the heat of the flat body of glass in the course of the contact with the flat body of glass. Since the mould plunger of glass is tempered according to the invention to a temperature which allows a moulding of the flat body of glass, but which is sufficiently low that an adherence of the flat body of glass to the mould plunger does not occur, the formed flat body of glass can be detached and/or removed from the mould plunger, in particular immediately, after it has been formed.

According to a further alternative embodiment of the invention, the level of the liquid metal bath can be further increased by the mould plunger during a suction process of the flat body of glass tempered to forming temperature, which can be possible either in that the metal bath per se is raised or by realised in that merely the surface level of the liquid metal in the bath is raised by a further addition of liquid metal. Such an increase of the liquid metal level can be continued until the flat body of glass on the one hand fits to the mould plunger and on the other hand is pressed against the mould plunger by the liquid metal. Such an embodiment has the advantage that the flat body of glass, which is initially tempered to forming temperature, can be further heated or cooled in a targeted manner by a temperature control of the metal bath, during which, according to the invention, the metal bath remains completely liquid.

According to the invention, a further heating or a sustained tempering of the flat body of glass to at least the forming temperature, or the associated viscosity of the flat body of glass depending on the type of glass, is particularly advantageous, for example, if the flat body of glass is to be moulded into forms with undercuts. In such a case, according to the invention, a multi-piece mould plunger is used, which makes it possible to demould the fully formed glass, which has been cooled to handling temperature, in a non-destructive manner.

In any case, the flat body of glass in contact with the mould plunger can also and in particular be cooled in a targeted and temperature-controlled manner, due to its contact with the liquid metal, in that the liquid metal itself is cooled and thereby heat is withdrawn from the flat body of glass in a targeted manner.

For demoulding the moulded flat body of glass that has been cooled to handling temperature, an overpressure can also be applied through the openings in the mould plunger, by which a detachment of the cooled flat body of glass from the mould plunger is caused and/or facilitated.

An introduction of the glass blank into a moulding space can, according to the invention, be done either by means of a holding device and/or a supporting device for the flat formation of glass, which is designed, for example, in the form of a gripper or a lance, which holds the glass blank and brings it, in particular moves it, into the moulding space between the molten metal and the mould plunger.

Alternatively, an introduction of the glass blank into the moulding space can also be done by means of the mould plunger itself and/or an external axial guide of the mould plunger. In the latter case, in addition to a movability of the mould plunger in the axial direction, the mould plunger is also designed translationally movable at an angle to the axial direction of the mould plunger. As mentioned above, the mould plunger and/or its axial guide, which in this case can also be moved translationally together with the mould plunger, has openings via which a vacuum can be applied which acts on the flat body of glass so that the glass blank can be held on the mould plunger and/or its guide by means of a vacuum.

After the glass blank has been brought into the moulding space, the glass blank can either be positioned floating loosely on the molten metal or, if desired, be held and fixed with its edges on the edge of the metal bath, i.e. on the upper edge of the container containing the molten metal, or on the guide of the mould plunger, so that a respective position, in particular final position intended for forming, of the glass blank to be moulded can be precisely defined and, if necessary, also corrected by a movement of the holding and/or supporting device or of the guide of the mould plunger, which can be moved in the axial direction independently of the mould plunger. When the molten metal and the mould plunger approach the flat glass blank from opposite sides, a forming of the glass blank takes place.

Thus, according to one embodiment of the invention, it is possible to position the glass blank or the molten glass on the molten metal, which is located in a vessel suitable for receiving the molten metal, so that the glass practically floats on the molten metal. When the mould plunger and the molten metal are moved towards each other, the mould plunger can now be lowered onto the glass which has been tempered to the forming temperature, whereby the mould plunger presses the glass, which is soft at this forming temperature, into the liquid molten metal and thereby forms it. In the course of this forming, the soft glass of the glass blank conforms to the glass contact surface of the mould plunger under the pressure of the mould plunger and takes on the form of the glass contact surface of the mould plunger, while the liquid molten metal serves as a counter-plunger to the mould plunger and exerts a homogeneous counter-pressure against the glass blank from the other side of the tempered glass blank.

According to a further embodiment of the invention, the approach of the mould plunger and the molten metal can also be effected by increasing the liquid level of the liquid metal of the molten metal, so that the mould plunger does not approach the molten metal from above, but the molten metal with floating glass blank approaches the mould plunger and presses the glass blank against the mould plunger in the course of this approach.

According to the invention, the liquid level of the molten metal can be increased by filling the liquid metal receiving compartment with more liquid metal so that the liquid level of the liquid metal increases; alternatively, the bottom of the liquid metal receiving compartment and/or the entire container in which the metal bath is located can be made movable so that the level of the liquid metal of the metal bath can be raised and lowered to allow the molten metal and the mould plunger to approach each other for the pressing operation and to allow the molten metal and the mould plunger to distance from each other for a subsequent demoulding operation.

The above embodiments of the invention may also be combined as desired, namely, for example, by both increasing the liquid level of the molten metal while simultaneously bringing the mould plunger closer to the surface of the molten metal. Since in this case two movements are carried out simultaneously towards each other, such a combination is suitable for the production of three-dimensionally formed flat glass items where, for example, a high production speed is desired.

According to a particularly preferred embodiment of the invention, the flat body of glass to be formed is introduced into the moulding space by means of a holding and/or supporting device in such a way that the flat body of glass to be formed comes to rest on the edge of the container which contains the liquid metal with its outer edge regions.

In the course of the forming process, the outer edge region of the flat body of glass to be formed, which is located on the edge of the container, is fixed on the edge of the container for the liquid metal, i.e. on the edge of the metal bath, by applying pressure to the edge region of the flat body of glass to be formed on the side opposite the container edge, so that the edge region of the flat body of glass to be formed is clamped on the container edge. According to the invention, such pressurisation of the flat body of glass to be formed at its edge regions can be carried out in a particularly advantageous manner circumferentially by the guide of the mould plunger, which can be moved independently of the mould plunger.

In this way, the flat body of glass to be formed is fixed to the edge of the metal bath during the moulding process and at the same time seals the metal bath against an overflow of metal when the level of the liquid metal in the metal bath is increased in the course of the moulding process and the mould plunger is lowered, in particular simultaneously.

According to this embodiment of the invention, one or more openings may be provided both on the guide of the mould plunger as well as in an upper section of the metal bath, for example on the edge thereof, which openings may serve both to vent as well as to ventilate the space which, after the flat body of glass has been fixed on the edge of the container, is located between the flat body of glass and the surface of the liquid metal. In this way, both lowering as well as raising the level of the liquid metal in the metal bath is possible without undesirable gas bubbles or underpressure forming between the flat body of glass and the surface of the liquid metal.

In this context, it should also be pointed out that according to the invention, not necessarily the entire flat formation of glass is tempered to a forming temperature, but rather, in an advantageous manner, only the area that is actually to be three-dimensionally formed. This means that the respective edge areas of the flat formation of glass can be kept at any time at a handling temperature at which the glass can be gripped and handled. In this way, it is possible, for example, to grip and hold these edge regions of the flat formation of glass even during the actual forming process by means of the holding and/or supporting device used in accordance with the invention for transporting the flat formation of glass into the moulding space and for removing it therefrom.

Furthermore, a forming of the tempered glass blank can also be done by placing the glass blank on a mould plunger located below during operation, subsequently tempering it and subsequently forming it by pouring liquid metal onto the glass blank, the glass blank, which is then at the forming temperature, being pressed against the mould plunger located below by the force of the weight of the liquid metal and an additional compressive force applied to the liquid metal, as desired, and thereby being formed. Also in this embodiment of the invention, a, possibly simultaneous, preferably axial, movement of the mould plunger can take place.

Due to the contact of the mould plunger with the glass surface formed by the mould plunger during the pressing process, a cooling of the glass surface occurs and thus a solidification of the flat body occurs, so that the flat body solidifies in its form produced by the pressing process.

After a solidification of the manufactured three-dimensionally formed flat glass item, this flat glass item is cooled to such an extent that the three-dimensionally formed flat glass item reaches a handling temperature. According to the invention, the handling temperature is defined by the fact that the respective formed glass has a viscosity of ≥10⁷ Pas. At such a viscosity of ≥10⁷ Pas, the respective glass is solidified to such an extent that, when the flat glass item is handled, no further deformation of the flat glass item occurs, so that the flat glass item can be handled and removed from the pressing device.

It should be noted at this point that, according to the invention, aluminium silicate glass is preferably used to produce the desired three-dimensionally formed flat glass item, but other glasses can also be used.

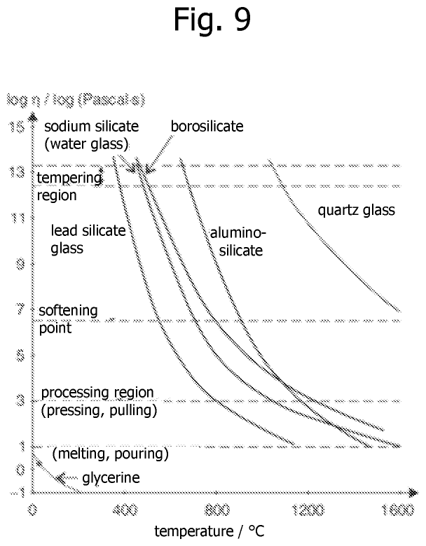

Since these different glasses to some extent have very different softening temperatures and processing temperatures, in the context of the present invention, the processing process is not based on a specific temperature, but on a viscosity required for a respective process, at which the respectively used glass has an aggregate state, such as liquid, softened or solid, necessary for the respective processing step, so that the respectively used glass can either be transported or formed or post-processed, for example fire-polished or otherwise surface-conditioned. In FIG. 9, exemplary correlations between the respective viscosities of different glasses at respective associated temperatures are given for different glasses.

After the desired three-dimensionally formed flat glass item has cooled to the handling temperature, demoulding of the cooled flat formation, i.e. the produced three-dimensionally formed flat glass item, takes place.

According to an embodiment of the invention, the flat formation of glass or at least a to be formed part of the flat formation of glass is preheated to a temperature at which the glass has a viscosity≥10^{6.5} Pas, preferably ≥10⁷ Pas, prior to step a), i.e. prior to an introduction into a moulding space between the molten metal and the mould plunger.

At such a viscosity, the glass blank can still be handled and gripped as well as held, but is already preheated to a temperature close to its forming temperature, so that a tempering of the flat formation, or its part to be formed, to the forming temperature can be done very quickly within the pressing tool.

In this context, it should be mentioned that the glass blank may already have softening phenomena in the course of the introduction of the glass blank into the pressing tool, since any impurities or microstructures in the blank surface are advantageously smoothed in the course of the pressing process according to the invention, so that a significant advantage of the method according to the invention also consists in the fact that microstructured blanks or blanks with minor damages to the surface can also be used for the process according to the invention without any problems. This applies in particular if any damaged surface is arranged on the metal bath side of the pressing tool.

Provided that for carrying out the method according to the invention no prefabricated glass blank is to be used, according to the invention, glass can be poured in liquid form onto the molten metal or the mould plunger and then tempered to its forming temperature by cooling. In this way, the method according to the invention can be used in a particularly wide variety of ways and is not limited to processing prefabricated glass blanks.

According to the invention, the tempering of the flat formation of glass is carried out, in the case of heating of the blank or flat formation, by means of a heater, for example an infrared (IR) heater and/or, optionally supplementary, by means of at least one induction heater and/or at least one microwave heater. Furthermore, heating or cooling of the blank can also or additionally be carried out by means of heat conduction by heating or cooling the molten metal.

Furthermore, according to the invention, it is also possible for the mould plunger to have fluid channels through which a separate temperature control of the, possibly multi-part, mould plunger is possible, so that the mould plunger can be both heated as well as cooled by means of a fluid in order to exhibit an optimum temperature for the respective process step. A gaseous fluid can preferably be used as the cooling fluid or heating fluid.

According to an embodiment of the invention, step c), i.e. moving the mould plunger and the metal bath towards each other, is carried out by means of at least one linear motor, in particular a servomotor. The use of such a motor generating a linear movement allows a very precise control of the pressing tool as well as, moreover, an immediate and instantaneous reaction in case of a pressure increase.

As mentioned above, the molten metal used according to the invention is a tin melt, as this material is inert to glass even at high temperatures and enables the production of a qualitatively optimised glass surface, while also enabling a “healing” of any defective areas on a surface of the glass blank.

According to the invention, this “healing” property of the molten tin is also used for post-processing of the finished three-dimensionally formed flat glass item in the form of a surface conditioning. For this purpose, the formed flat formation of glass can be turned after it has cooled down to handling temperature, for example by means of a gripper and/or a vacuum holding device, and brought into contact with the liquid tin with the side that did not come into contact with the molten metal during the moulding process. Through the contact of the glass with the liquid tin, any defective spots in the glass surface and/or any stresses on the glass surface are “corrected” or repaired, respectively, without the need for a manual or mechanical post-processing of the glass surface, for example by grinding or polishing.

According to a preferred embodiment, the molten metal with which the flat formation of glass is brought into contact during a surface conditioning is subjected to a high-frequency vibration, which can be generated by means of ultrasound, for example. In this way, a planar uniform contact of the flat formation of glass with the liquid metal, namely liquid tin, is favoured.

Furthermore, the process according to the invention is carried out in the absence of oxygen, i.e. preferably in an atmosphere which is inert with respect to the glass, the liquid metal, in particular the molten tin, and the material of the mould plunger, for example in a noble gas atmosphere, in particular an argon atmosphere, and/or a nitrogen atmosphere and/or in a carbon dioxide atmosphere. In this way, any oxidation of these components as well as in particular of the tin bath can be avoided.

According to a preferred embodiment of the invention, the tin bath is layered-over with the respective inert gas used, where heavy noble gases as well as carbon dioxide are particularly well suited due to their higher specific gravity compared to air. According to this embodiment, the container in which the liquid metal, in particular tin, is located, in its region adjacent to the flat formation glass and/or to the guide of the mould plunger is in fluid communication with a reservoir for the respective glass, with which the inert atmosphere is generated above the metal bath.

According to the invention, for the purpose of an inert gas supply, for example, the one or more openings can also be used, with which a venting and ventilation of the space between the metal bath and the flat body of glass to be formed is possible.

In order to be able to carry out the actual forming process according to the invention in an inert atmosphere, the glass blank, which is held either by a gripper, a vacuum holding device or on a support device, is brought through an airlock into a space with a controlled atmosphere, wherein this space is filled with the respectively desired inert and/or protective gas or mixtures thereof and preferably is under a slight overpressure in order to prevent that ambient air penetrates into this space with controlled atmosphere.

Inside the airlock, first an evacuation and then a flooding of the space with inert and/or protective gas takes place. Since this process takes some time, according to the invention a preheating of the glass blank can be carried out at the same time in order to achieve in this way a shortening of the time sequence of the method according to the invention.

At this point, it is also conceivable that instead of an evacuation of the airlock chamber, a displacement of the air therein with the inert and/or protective gas is carried out, whereby the inert and/or protective gas which streams out of the moulding chamber due to the overpressure prevailing therein can be used for this purpose.

According to a further alternative embodiment of the invention, it is further possible to position the entire pressing apparatus according to the invention under an inert and/or protective gas bell, which in turn is open downwards and allows a controlled atmosphere to be maintained inside the bell due to a slight overpressure inside the bell. In this case, the glass blank and the finished glass product are fed in and out of the bell from below. Since the bell is open downwards, an inert gas which has a lower specific gravity than air is preferably suitable for this embodiment of the invention.

In the case where the glass blank is supported on a support device, the heating of the glass blank, preferably by means of infrared radiation, takes place essentially from above, whereas heating of the glass blank is possible both from above as well as from below when the glass blank is held and/or rests with its edges on the edge of the metal bath.

It should be mentioned that the use of a gripper for holding the glass blank is advantageous according to the invention, since the blank can be both moved as well as turned together with the gripper, which is extremely advantageous, for example, for carrying out the surface conditioning.

According to the invention, the formed flat glass item can be removed from the pressing tool by means of the gripper, but also by means of a vacuum holding device, which can be integrated into the mould plunger and/or into the, preferably annular, guide of the mould plunger at least partially surrounding the mould plunger. In this case, according to the invention, the mould plunger is designed to be movable not only axially, but also laterally. Such an embodiment of the invention is particularly advantageous, since the mould plunger is in contact with the formed flat formation during the pressing process anyway and thus also serves as protection for the pressed glass surface.

For removing the flat glass item from the pressing tool, the mould plunger can have micro-openings via which a vacuum can be applied, through which the formed flat glass item can be held on the mould plunger. In this way, according to the invention, it can be ensured that the finished formed flat glass item adheres securely to the mould plunger during the removal process and can be separated from the mould plunger after removal in a simple manner by releasing the vacuum.

As mentioned above, the guide of the mould plunger surrounding the mould plunger, which for example in the case of a round mould plunger can be designed as a ring, can also have openings through which a vacuum can be applied. This guide, which can also functionally, for example, be referred to as a cover ring can rest against the glass blank along the edges of the glass blank and hold the glass blank in this way when an underpressure is applied through the openings formed in the guide, so that the blank or its edge is suctioned by the guide. In this way, either a transport of the glass blank as well as a lifting and picking-up of the three-dimensionally formed flat glass item from the molten metal can carried out.

Furthermore, the glass blank can also be held by a gripper or a supporting device during the entire manufacturing process, whereby the glass blank is first placed on the supporting device or gripped by the gripper in order to carry out the process according to the invention. With the aid of this holding and/or supporting device, which can be connected to a transport carriage or another transport device, for example, the glass blank is then transported from the ambient atmosphere into the airlock and heated there to a temperature which still permits gripping and transporting of the glass blank, while at the same time an exchange of atmosphere takes place inside the airlock, in the course of which the ambient atmosphere is replaced by an inert and/or protective gas atmosphere. After completion of the atmosphere exchange, the blank is then conveyed into the moulding space and positioned between the volume or container for the molten metal and the mould plunger. Subsequently, a heating of the glass blank up to the forming temperature takes place. The glass blank is still held or supported during this process. The glass blank is now formed by bringing the molten metal and the mould plunger closer together, whereby the glass blank comes into intimate contact with the molten metal on the one hand and with the mould plunger on the other hand and is moulded in that the molten metal acts as a counter plunger to the mould plunger and presses the glass blank exactly against the mould contour of the mould plunger.

When the glass blank is held and fixed on the edge of the metal bath in a way that preferably seals the metal bath, additional liquid metal, i.e. liquid tin, can be pressed into the volume provided for the metal bath in the course of the moulding process, so that the level of the metal bath, in particular tin bath, is raised to such an extent that the glass blank comes into contact with the liquid tin, while the glass blank is pressed into its desired form by the moulding plunger from the opposite side.

During the pressing process, respectively after a completion of the pressing process, a cooling of the formed flat glass item takes place at the same time, so that the then three-dimensionally formed flat glass item solidifies in the desired form. According to the invention, the cooling is primarily initiated by the mould plunger itself, as this has a slightly lower temperature towards the end of the pressing process than the forming temperature of the glass. Since the mould plunger has a direct and immediate contact with the entire formed surface of the flat glass item, a uniform cooling of the flat glass item below the forming temperature to a handling temperature can take place at which the viscosity of the flat glass item is increased such that no further forming is possible.

According to one embodiment of the invention, the mould plunger can have a heating device and a cooling device for this purpose, so that the mould plunger can be tempered to the temperature required for the respective process step during the performance of the method according to the invention. Such a heating or cooling device can, for example, be designed in the form of channels or conduits formed inside the mould plunger, through which a heating or cooling fluid can flow. Alternatively, the mould plunger can also be heated inductively, for example. The same also applies to the guide of the mould plunger, as this guide according to the invention also has a heating and/or cooling device in order to avoid any stresses between the guide and the mould plunger.

Furthermore, it should be pointed out at this point that the metal bath can also be both heated as well as cooled, depending on the process step, so that the glass blank has an optimised temperature and viscosity for forming the glass blank. This means that, in addition to using an induction and/or infrared heater to heat the glass blank, the glass blank can also be heated by contact with the metal bath, or be cooled if the metal bath is cooled.

Furthermore, it should be noted that the level of the metal bath can be lowered again after a completed forming process. For this purpose, the metal bath is in fluid communication with a reservoir and/or compensation container for liquid metal, whereby the liquid metal necessary to replenish the metal bath can also be taken from this container.

After the formed flat glass item has solidified to such an extent or has assumed such a high viscosity that further undesired deformation of the flat glass item no longer takes place, the flat glass item is picked up and turned over and is with its side, which did not come into contact with the metal bath during the forming process, also brought into contact with the metal bath, so that the surface that was previously only in contact with the mould plunger is also brought into contact with the liquid tin, so that any impurities are “healed” by this contact with the liquid tin and a perfectly smooth and defect-free surface of the flat glass item is formed.

In this way, the formed flat glass item produced according to the invention obtains an optimised perfect surface on both sides.

After the surface conditioning has been carried out, the now completely formed and surface-treated flat glass item is conveyed out of the moulding device and back into an ambient atmosphere by means of the holding and/or support device and its transport device through an airlock, in which again an exchange of atmosphere takes place.

According to a further embodiment of the invention, the demoulding step may be carried out with the aid of pressurising the formed flat formation with compressed air. This is in particularly useful when the formed flat glass item comes into intimate contact with the mould plunger or the guide of the mould plunger, for example the ring, during cooling, for example by shrinkage. In this case, compressed air may be used to gently push the formed flat glass item away from the moulding plunger and/or its guide.

As aforementioned, the demoulded flat formation, respectively the finished formed flat glass item, is surface-treated according to the invention at least on one side, namely in particular by bringing the desired side to be treated into contact with the metal bath or a further metal bath, preferably while turning the flat formation, wherein the further metal bath preferably has a lesser temperature than the metal bath used during the moulding process, i.e. in step c).

At this point, it should be noted that the metal bath used for post-processing of the one or more surfaces of the three-dimensionally formed flat glass item may be the same metal bath that was used to form the glass blank. Alternatively, a second metal bath may be provided which is used to carry out the surface conditioning or treatment. According to the invention, this second metal bath is also a tin bath, whereby this second metal bath according to the invention has a somewhat lesser temperature than the metal bath used for moulding. This is advantageous in particular because a smoothing and healing of the surface of the flat glass item only requires a contact with liquid tin, whereby the tin need not, however, such highly tempered that a melting of the glass takes place; rather, it is sufficient for carrying out the surface conditioning if solely a few micrometres of the flat glass item's surface to be processed are softened to such an extent that a smoothing of the glass can take place due to the surface tension of the glass.

Incidentally, the method according to the invention can be carried out both as a continuous, i.e. through-feed process, as well as as a so-called batch process, wherein the respective glass item is held by means of a holding device or, alternatively, is handled by means of at least one supporting device as well as, if appropriate, at least one turning device.

According to a further embodiment of the invention, the glass blank can also be placed outside the moulding device, i.e. in ambient atmosphere, also on a supporting device, such as a lance, by means of which it is then in turn conveyed by a transport device, such as a carriage or other displacement mechanism, into the airlock, in which an exchange of atmosphere towards an inert atmosphere takes place. In this airlock, the glass blank can be preheated to a temperature at which its viscosity is still sufficiently high for handling and transporting of the glass blank. Subsequently, i.e. after the exchange of atmosphere, the glass blank leaves the airlock lying on the support device and is guided by means of the lance, respectively the support device, between the tin bath, respectively the volume or the container for receiving the tin bath, and the plunger, i.e. the mould plunger, and its guide, i.e. for example a ring. There, the guide of the mould plunger, which is arranged above the glass blank, takes over the further transport of the glass blank, in that the guide sucks the edges of the glass blank via vacuum nozzles, lifts them off the supporting device, e.g. lance, and then deposits them on the tin bath or its edge. Subsequently, the mould plunger, which was initially retracted behind the guide, is moved forward towards the glass blank by the guide, while on the other side of the glass blank the level and/or the pressure of the metal bath is raised or increased to such an extent that the metal bath acts as a counter-plunger to the mould plunger and the glass blank arranged between the mould plunger and the metal bath is formed.

After the glass blank has been formed, the formed flat glass item produced is again gripped by the ring, i.e. sucked in by underpressure, and lifted off the metal bath or the edge of the metal bath.

Subsequently, the formed flat glass item is either deposited on a second support device, such as a second lance, and again transported out of the forming device through an airlock.

Alternatively, according to the invention, the formed flat glass item can also be subjected to a surface conditioning before being discharged from the moulding device. In this case, the flat glass item lifted from the metal bath by the guide of the mould plunger is gripped on its side opposite the guide by a vacuum gripper and turned in such a way that the side of the formed flat glass item which has not yet come into contact with a metal bath is brought into contact with the tin bath, so that by the contact of the glass with the tin bath a healing of any defects can take place. Also in this case, either the tin bath used for moulding or a tin bath downstream of this tin bath, which may optionally have a lower temperature than the tin bath used for moulding, can be used.

It should also be mentioned at this point that the vacuum gripper, i.e. the vacuum holding device used, can either deposit the formed flat glass item after the surface conditioning has been carried out again on a support device or move it out of the moulding device directly through the airlock.

Furthermore, it should be mentioned at this point that the actual forming process as well as, if necessary, the surface conditioning of the flat glass item can also be carried out at underpressure, respectively in a largely vacuumed room.

Furthermore, the object according to the invention is also solved in particular by an device for producing a glass article, in particular a three-dimensionally formed flat glass item, in particular by means of a method according to the above statements, wherein the device has a receiving compartment suitable for receiving molten metal, in particular tin, as well as a mould plunger opposite the receiving compartment, wherein in the direction of the receiving compartment and adjoining the mould plunger, a moulding space being is arranged, into which a flat formation of glass, in particular a glass blank or liquid glass, can be introduced, and wherein the mould plunger and the molten metal can be moved towards one another, and the mould plunger optionally has openings for the application of underpressure or overpressure, so that the flat formation of glass can be pressurized, on the one hand, from the mould plunger and, on the other hand, from the molten metal, and can be formed by the pressurisation on both sides and/or by suctioning and conforming the flat formation of glass onto the mould plunger.

According to an embodiment of the invention, the receiving compartment for liquid metal, in particular tin, is in fluid communication with a compensation container which is suitable for receiving and dispensing molten tin and can be pressurised if necessary.

In this way, it is possible, according to the invention, on the one hand to increase a counterpressure of the tin during a moulding process as well as on the other hand to use tin from the compensation container to increase the liquid metal level, respectively height of liquid metal. Furthermore, the compensation container can be used to control the level of the metal level when the mould plunger presses the flat formation of glass heated to the forming temperature into the metal bath for forming.

According to the invention, the mould plunger is made of or coated with a high temperature resistant material, such as a refractory metal, for example, steel, gold, copper, ruthenium, osmium, zirconium, hafnium, niobium, tantalum, chromium, molybdenum or tungsten, or a refractory alloy, or a ceramic, such as a carbide or nitride, which is inert to glass at temperatures in the range of 700° C. to 1600° C.

As aforementioned, the mould plunger may comprise at least one cavity, in particular at least one channel and/or conduit, through which a heating or cooling fluid, in particular a gaseous one, may flow.

In this way, a separate tempering of the mould plunger is possible, so that the temperature of the mould plunger can be adapted to a respective process step. For example, the mould plunger can be cooled in a controlled manner to accelerate cooling of the finished formed flat glass item or can be kept at an elevated temperature during the pressing process, if this is desired.

Furthermore, the mould plunger and/or its guide can have openings via which an underpressure or an overpressure can be generated at a contact surface between the flat formation of glass and the mould plunger.

In this way, it is possible to use the mould plunger and/or its guide itself as a transporting tool for the glass blank on the one hand as well as for the finished formed flat glass item on the other hand, by holding and transporting the glass blank or the flat glass item with underpressure on the mould plunger. An application of overpressure can be used if the glass blank or the flat glass item does not detach by itself from the mould plunger. In the event that an application of overpressure is required for detachment of the glass blank in the pressing tool, an inert gas, such as nitrogen or argon, may be used to create the overpressure. Compressed air is also applicable at this point. For this purpose, the gas supply of the mould plunger may have a reversing valve so that, as desired, a desired gas or air may be used for detaching the article from the mould plunger.

According to a further advantageous embodiment of the invention, the device may comprise at least one transport carriage for introducing a flat formation of glass into the moulding space and/or removing a formed flat glass item from the moulding space through an airlock of the device which serves for an exchange of the outer atmosphere against an inert gas and/or protective gas atmosphere or for generating an underpressure or vacuum, respectively, within the actual moulding space and/or a post-processing space. Here, the transport carriage can be moved between a position in the pressing tool in a pressing position and a position outside the pressing tool, so that both the glass blank as well as the finished formed flat glass item can be transported with the aid of the transport carriage. This way, for example, either the mould plunger and/or its guide or, alternatively, a holding device or other supporting device, such as a lance, can be attached to the transport carriage in order to convey both the glass blank into the pressing tool as well as the finished formed flat glass item subsequently out of the pressing tool. Furthermore, the transport carriage can also have several mould plungers, holding devices and/or supporting devices, each of which alternately or successively forms and conveys the glass blank and the finished formed flat glass item. In this way, according to the invention, for example, a, preferably continuous, circular operation is possible.

As aforementioned, the apparatus according to the invention can be operated either in batch mode or in continuous mode, as desired. While the device according to the invention has only one airlock in the case of operating in batch mode, the device according to the invention can also have two or more airlocks, preferably arranged opposite one another, for operation in continuous mode, wherein a first airlock serves as an input airlock and a second, in particular opposite, airlock serving as an output airlock.

Furthermore, the device according to the invention comprises at least one heater, for example an infrared (IR) heater and/or, optionally supplementary, at least one induction heater and/or at least one microwave heater, in order to heat in particular the glass blank and, if desired, also components of the pressing tool, in particular the metal bath.

According to a further advantageous embodiment of the invention, the mould plunger may be interchangeable, preferably by means of at least one coupling device. Possible further couplings may be provided for components connected to the mould plunger, such as a fluid supply or a vacuum device.

A further important aspect of the invention further consists in that the mould plunger can be designed as one-piece but also as multi-piece. A multi-piece design of the mould plunger makes it possible, for example, to produce a flat glass item having undercuts, wherein the mould plunger, or the respective part of the mould plunger covering the respective undercut, can be retracted to such an extent that a demoulding of the formed flat glass item is possible. According to the invention, the respective parts of a mould plunger designed as multi-piece are movable individually and independently of each other, wherein the individual parts of such a multi-piece mould plunger can be joined tightly to each other during or before a pressing or moulding process, so that the multi-piece mould plunger has a smooth and homogeneous surface during the moulding process for carrying out the moulding of the flat glass item.

Furthermore, the object according to the invention is also solved by the use of a molten metal, in particular a tin melt, which serves as a counter plunger to a solid mould plunger and is used for a production of a three-dimensionally formed flat glass item.

In summary, the method according to the invention as well as its advantages, i.e. in particular the use of liquid tin as a liquid glass contact material, can be written down as follows.

The use of liquid tin makes it possible to implement the moulding process not exclusively in the phase of the cooling process, but to employ it already one step before, i.e. in the phase of conditioning the glass to an optimal moulding temperature and temperature homogeneity. This allows that the glass can be fed to the moulding process under optimal conditions.

Furthermore, the method according to the invention allows the temperature parameters in the process to be extended, as the temperature of the tin not only allows the temperature delta between the mould and the glass to be minimised, but also allows the temperature delta to be reversed.

Thus, when the glass blank is loaded, the tin bath can have a higher temperature than the glass itself has when it is loaded, in which case the tin bath can transfer its temperature to the glass.

Furthermore, due to the high thermal conductivity of the tin, the tin bath enables a very fast temperature control during the process of heating-up as well as a preconditioning of the glass blank in the form of a heating-up to the forming temperature and a holding of the temperature during the mould process as well as a control of the temperature parameters during the forming, whereby a forming time window is advantageously increased.

This results in improved process control through an active control of both the time as well as the forming pressure, the holding pressure and the temperature control at the individual process stages. This in turn enables a glass homogenisation over time, i.e. heating through, reheating and a control of the temperature gradients in the glass during forming and cooling.

Thus, there is increased latitude in temperature control by an active temperature control and not, as in the prior art, by a passive thermal conductivity or an indirect air/water cooling of the mould tool.

A regulation of the tin pressure can be done by means of at least one servo valve.

A process control can be reduced to a minimum in the sense of a reduction of the process time in the actual moulding/forming process, for example in that an upstream heating of the glass blank as well as, if necessary, downstream processes such as a dedicated cooling are included.

Furthermore, by the use of a tin bath in the course of the moulding process according to the invention an improvement of the surface quality of the formed three-dimensional flat glass item is possible due to the contact with tin.

Thus, a formation of a thin tin oxide layer on the formed glass surface as an inherent component of the glass leads to an optimised surface structure of the formed three-dimensional flat glass item.

Furthermore, there is the possibility, in an intermediate process step, to bring that side of the glass component which was not in contact with the tin bath due to the three-dimensionality of the glass item into contact with warm liquid tin in a temperature range in which no geometric deformation takes place, so that a “healing” of surface defects of the glass is effected.

Further embodiments of the invention will be apparent from the dependent claims.

In the following, the invention will be described with reference to an execution example, which will be explained in more detail with reference to the figures. Hereby show:

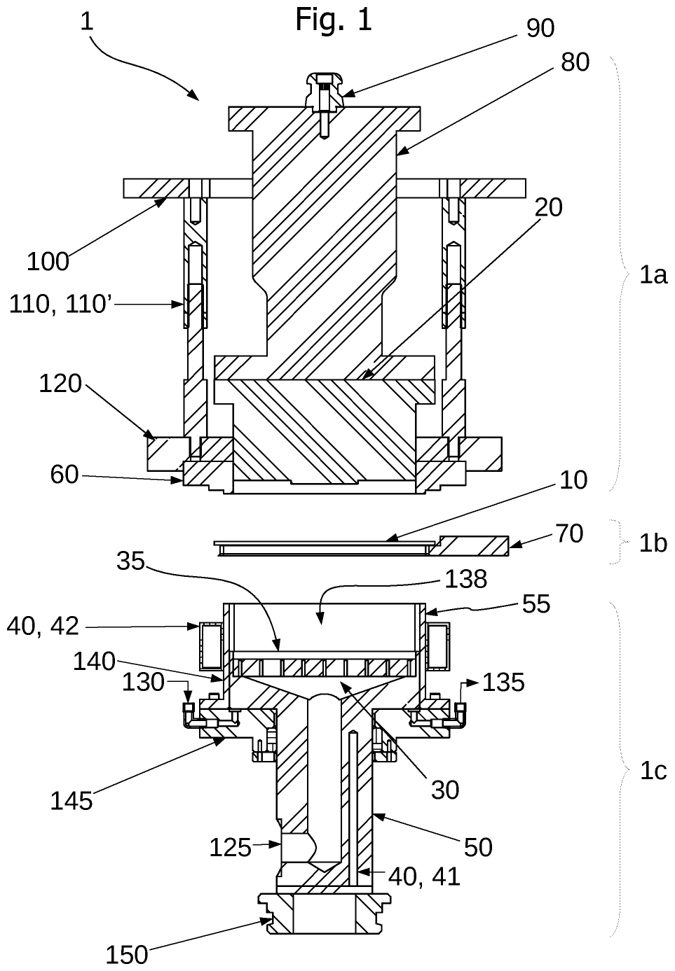

FIG. 1 a schematic illustration of the device according to the invention for producing a three-dimensionally formed flat glass item according to a first embodiment in opened position;

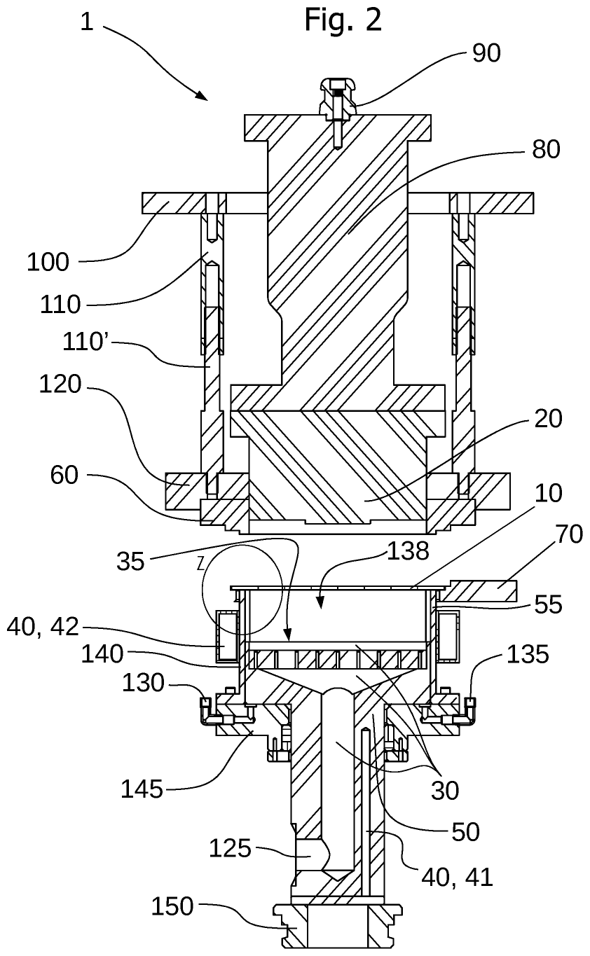

FIG. 2 a schematic illustration of the device according to the invention in accordance with the embodiment shown in FIG. 1 with a flat glass blank laid on;

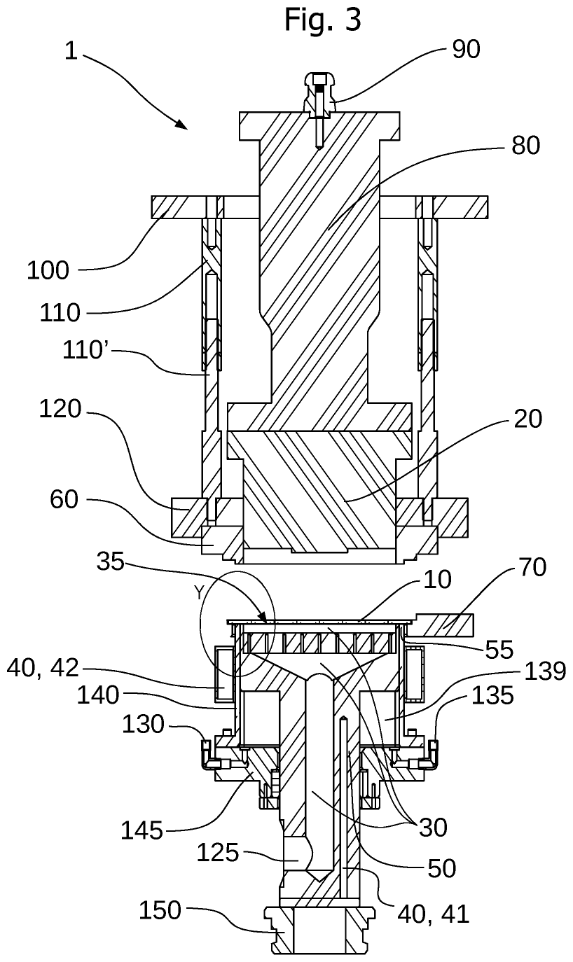

FIG. 3 a schematic illustration of the device according to the invention in accordance with the embodiment shown in FIG. 1 in preparation for the moulding process;

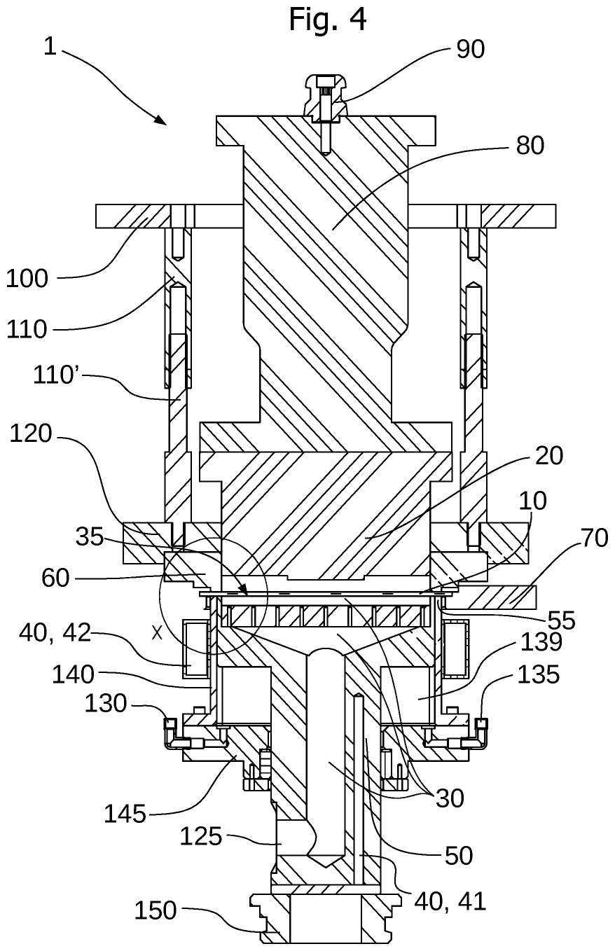

FIG. 4 a schematic illustration of the device according to the invention in accordance with the embodiment shown in FIG. 1 in further advanced preparation for the forming process;

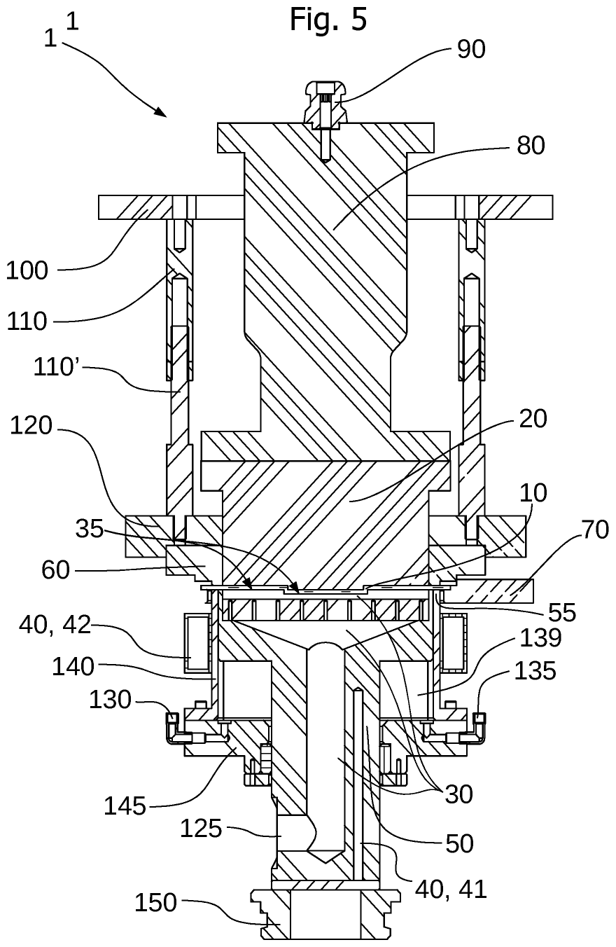

FIG. 5 a schematic illustration of the device according to the invention in accordance with the embodiment shown in FIG. 1 during the moulding process;

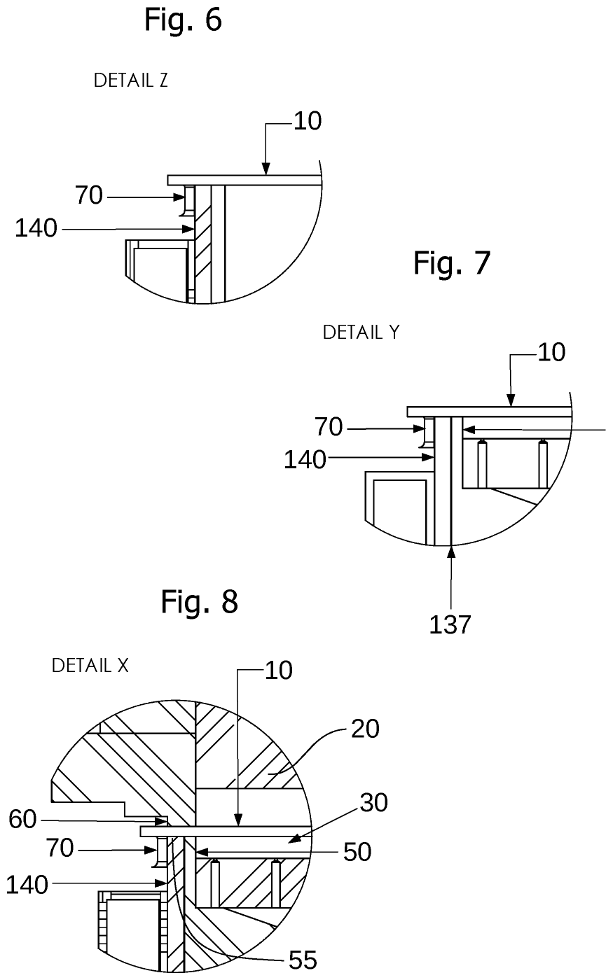

FIG. 6 a schematic enlarged detail illustration of a section Z marked in FIG. 2;

FIG. 7 a schematic enlarged detail illustration of a section Y marked in FIG. 3;

FIG. 8 a schematic enlarged detail illustration of a section X marked in FIG. 4; and

FIG. 9 a diagram which exemplary shows a correlation between the respective viscosity of different glasses with the respective associated temperature.

In the following description, the same reference signs are used for identical and similarly acting parts.

FIG. 1 shows a schematic illustration of the device 1 according to the invention for producing a three-dimensionally formed flat glass item 10 according to a first embodiment. According to FIG. 1, the device 1 according to the invention is shown in an open starting position.

The device 1 according to the invention essentially comprises three sub-units, namely a plunger unit 1a, a transport unit 1b for the flat formation of glass 10 as well as a counter-plunger unit 1c, which is designed as a metal bath unit.

The plunger unit 1a in turn comprises the mould plunger 20, a plunger receiver 80 to which the mould plunger 20 is attached by means of a fastening device, preferably a quick clamping system 90. Furthermore, the plunger unit 1a comprises a cover ring unit, which in turn comprises a fastening ring 100, a suspension bolt 110, which is fastened to the fastening ring 100, is oriented at right angles downwards, i.e. in the direction of the counter plunger unit 1c, and in which a bolt 110′ is guided in the axial direction, as well as a receiver 120 and a cover ring 60. The receiver 120 serves to fasten the bolt 110′, which in turn is slidably arranged in the suspension bolt 110, so that a guiding of the plunger unit 1a and in particular of the mould plunger 20 is possible by a cooperation of the fastening ring 100, suspension bolt 110, bolt 110′, receiver 120 and cover ring 60.

The transport unit 1b essentially consists of a holding device 70, with which it is possible to hold, in particular support, and transport the flat formation of glass 10.

According to the embodiment example of the invention illustrated in FIG. 1, the counter-plunge unit, or metal bath unit 1c, comprises two heaters 40, which in turn comprise at least one heating element 41 and a coil 42 for inductively heating the metal bath. Furthermore, the counter-plunge unit 1c comprises a tub-formed container 50 for receiving liquid metal, in particular tin, 30 as well as an inlet and outlet opening 125 for the liquid metal, as well as an inert gas inlet 130 and an inert gas outlet 135, via which an inert gas, for example carbon dioxide, can be supplied and discharged for overlaying the metal bath 30.

Furthermore, the counter-pressure unit 1c comprises an inert gas compartment 138, which is arranged above a level 35 of the metal bath 30 and serves to overlay the metal bath 30 with an inert gas that is specifically heavier than air. The inert gas compartment 138, in turn, is in fluid communication, in particular gas communication, with an inert gas receiving compartment 139 via an annular gap 137 illustrated in detail in FIG. 7. The inert gas receiving compartment 139 as well as, if desired, the annular gap 137 itself are in fluid communication, in particular gas communication, with the inert gas inlet 130 and the inert gas outlet 135.

Furthermore, the counter-plunge unit 1c is provided with a quick-change system 150 for connection to a press or lifting device (not shown), wherein it is possible by means of such a lifting device to lift or lower the counter-plunge unit 1c in its entirety and/or the container 50 relative to, inter alia, the outer sleeve 140 and the sealing disc 145 in the vertical direction. Such a relative movement is apparent, for example, from a comparison of FIG. 1 and FIGS. 3 to 5, wherein FIGS. 1 to 5 show respective operating states of the device according to the invention, which are reversibly passed through by the device according to the invention for the production of the three-dimensionally formed flat glass item 10.

According to the invention, the counter plunge unit 1c further comprises an outer sleeve 140 surrounding the metal bath 30 and having a sealing disc 145.

According to FIG. 1, the plunger unit 1a, the transport unit 1b and the counter plunge unit 1c are illustrated in schematic view at a distance from each other.

FIG. 2 shows the further course of a moulding process carried out according to the invention for producing a three-dimensionally formed flat glass item 10, in which the flat glass item 10 is deposited on the edge 55 of the tub for liquid metal 50 by means of the holding device 70.

In the further course of the moulding process performed according to the invention for producing a three-dimensionally formed flat glass item 10, it is shown in FIG. 3 that the container 50 for the liquid metal 30 is raised relative to the outer sleeve 140 and the sealing disc 145, wherein due the lifting of the container 50 for the liquid metal the inert gas has been conveyed, in particular pressed, out of the inert gas compartment 138 and into the inert gas receiving compartment 139 via the annular gap 137. In this state, the flat glass blank 10, on the one hand, rests with its edge section on the tub edge 55 of the container 50 for liquid metal 30 and, on the other hand, is in contact with the liquid metal 30 on its underside. By the contact of the edge section of the flat glass blank 10 with the tank edge 55 it is ensured that this edge section of the flat glass blank 10 remains cooler in relation to the section of the flat glass blank 10 in contact with the liquid metal 30 and, after lowering the cover ring 60 onto the edge section of the flat glass blank 10, a seal such that no metal can escape between the tank edge 55 and the flat glass blank 10 in the course of a subsequent pressing process illustrated in FIG. 5 is provided.

The operating state of the device according to the invention illustrated in FIG. 5 shows the manner in which the flat glass blank 10 is formed into a three-dimensionally formed flat glass item 10 by lowering the mould plunger 20. Since liquid metal 30 is displaced in the course of a moulding process, depending on the desired form of the three-dimensionally formed flat glass item 10, the receiver 50 for the liquid metal 30, respectively the tub provided for this purpose, with an inlet and outlet opening 125 for liquid metal 30 is in fluid communication with a pressurisable compensation container (not shown) via which, on the one hand, the level of the metal bath can be controlled and via which, on the other hand, a counterpressure can be generated with respect to the mould plunger 20, which then acts by means of the metal bath 30 on the side of the flat glass item 10 to be formed opposite the mould plunger 20. The further FIG. 6, FIG. 7 and FIG. 8 show respective detailed illustrations of the sections Z, Y and X marked in FIG. 2 to FIG. 4.

In the further course of the production of the desired three-dimensionally formed flat glass item 10, after the moulding of the flat glass item 10, a process control opposite to the moulding of the device according to the invention is carried out, in which the plunger unit 1a is removed from the counter plunge unit 1c and subsequently the transport unit 1b with the flat glass item 10 is removed from the moulding position. Subsequently, the formed flat glass item 10 can be removed from the holding device 70, for example by means of a vacuum holder, turned over and placed on another metal bath 30 for the purpose of surface conditioning; it is also conceivable at this point that the edge sections of the flat glass item 10 are first removed and that the flat glass item 10, after being turned over, is surface conditioned in the same metal bath 30 that also served as a counter plunge to the mould plunger 20.

At this point, it should be noted that all of the parts described above, considered alone and in any combination, in particular the details illustrated in the drawings are claimed to be essential to the invention.

Modifications thereof are familiar to those skilled in the art.

### LIST OF REFERENCE SIGNS

1 device according to the invention
1a plunger unit
1b transport unit
1c counter plunge unit, metal bath unit
10 flat formation of glass
20 mould plunger
30 melt of liquid metal, metal bath
35 level of metal bath
40 heater
41 heating element
42 coil
50 receiver, container, tub for liquid metal bath
55 tub edge
60 frame, ring, cover ring
70 holding device
80 plunger receiver
90 quick clamping system
100 fastening ring
110 suspension bolt
110′ bolt
120 receiver
125 inlet and outlet opening for liquid metal
130 inert gas inlet
135 inert gas outlet
137 annular gap
138 inert gas compartment
139 inert gas receiving compartment
140 outer sleeve
145 sealing disc
150 quick-change system

1. A method of forming a glass item comprising the following steps:
a) arranging a flat formation of glass, for example a flat glass pane of homogeneous thickness or a flat glass pane of inhomogeneous thickness or a preformed flat glass pane blank or liquid two-dimensionally spread glass, between a mould plunger and a melt of liquid metal, in particular tin;
b) tempering of at least one part to be formed of the flat formation of glass to a forming temperature of the glass at which the glass has a viscosity in the range from 10 Pas to 10^{6.5} Pas;
c) forming the flat formation of glass by moving the mould plunger and a surface of the molten metal towards each other, preferably by means of at least one linear movement, for example by means of a linear motor or servomotor, so that the flat formation of glass is pressurised either by the mould plunger on the one hand and by the molten metal on the other hand and is formed by the pressurisation on both sides and/or by a suctioning and conforming of the flat structure of glass onto the mould plunger;
d) cooling the formed flat formation of glass to a handling temperature below the forming temperature at which the glass has a viscosity of ≥10⁷ Pas; and
e) demoulding the cooled flat formation.

2. The method according to claim 1, wherein the flat formation of glass is preheated before step a) to a temperature at which the glass has a viscosity≥10^{6.5} Pas.

3. The method according to claim 1, wherein the flat formation of glass is provided in that the glass is poured in liquid form onto the molten metal or the mould plunger and subsequently cooled to the forming temperature.

4. The method according to claim 1, wherein the tempering of the flat formation of glass is carried out by means of at least one heater, for example an infrared (IR) heater and/or, optionally supplementary, by means of at least one induction heater and/or at least one microwave heater, and/or by heating or cooling the molten metal.

5. The method according to claim 1, wherein the method is carried out in the absence of oxygen, preferably in an atmosphere inert to the glass, the liquid metal, in particular the molten tin, and the material of the mould plunger, for example in a noble gas atmosphere, in particular an argon atmosphere, and/or a nitrogen atmosphere and/or a carbon dioxide atmosphere.

6. The method according to claim 1, wherein the demoulding step is carried out by means of pressurising the formed flat formation of glass, namely three-dimensionally formed flat glass item, with compressed air.

7. The method according to claim 1, wherein the demoulded flat formation is surface-conditioned at least on one side, in particular by bringing this side to be surface-conditioned into contact with the metal bath or a second metal bath, preferably while turning over the flat formation, wherein the second metal bath preferably has a lower temperature than the metal bath used during the moulding step c).

8. A device for producing a glass item, in particular a three-dimensionally formed flat glass item, in particular by means of a method according to claim 1, wherein the device has a receiving compartment suitable for receiving molten metal, in particular tin, as well as a mould plunger opposite the receiving compartment, wherein between the receiving compartment and the mould plunger a moulding space is formed, into which a flat formation of glass, in particular a glass blank or liquid glass, can be introduced, and wherein the mould plunger and the molten metal can be moved towards one another and the mould plunger has, if appropriate, openings for the application of underpressure or overpressure, so that the flat formation of glass can be subjected to pressure on the one hand by the mould plunger and on the other hand by the molten metal and can be formed by the application of pressure on both sides and/or by suctioning and conforming the flat formation of glass onto the mould plunger.

9. The device according to claim 8, wherein the receiving compartment is in fluid communication with a container, in particular a compensation container, which is suitable for receiving molten tin and can optionally be pressurised.

10. The device according to claim 8, wherein the mould plunger is made of a high-temperature-resistant material, such as, for example, a refractory metal, for example, steel, gold, copper, ruthenium, osmium, zirconium, hafnium, niobium, tantalum, chromium, molybdenum or tungsten or a refractory alloy or a ceramic, such as, for example, a carbide or nitride, which is inert to glass at temperatures in the range from 700° C. to 1600° C., or is coated with such a high-temperature-resistant material.

11. The device according to claim 8, wherein the mould plunger comprises at least one cavity, in particular at least one channel and/or conduit, through which a, in particular gaseous, heating or cooling fluid can flow.

12. The device according to claim 8, wherein the mould plunger comprises at least two plunger components, wherein preferably each plunger component is independently movable.

13. The device according to claim 8, wherein the mould plunger is surrounded, in particular guided, by a frame, in particular a ring, such as, for example, a cover ring, wherein the frame, in particular a ring, surrounding the mould plunger optionally has openings, whereby it is possible to generate an underpressure or an overpressure via the openings on a contact surface between the flat formation of glass and the mould plunger.

14. The device according to claim 8, wherein the device comprises at least one transport device, for example a transport carriage, wherein the at least one transport device is intended for guiding a holding device and/or a supporting device for the flat formation of glass, for example in the form of a gripper or a lance, in order to introduce the flat formation of glass into the moulding space and/or to remove a formed flat glass item from the moulding space.

15. Use of a molten metal, in particular molten tin, as counter plunge to a fixed mould plunger for a manufacture of a three-dimensionally formed flat glass item.
